(19) United States
(12) Patent Application Publication
(10) Pub. No.: US 2019/0168620 A1
(43) Pub. Date: Jun. 6, 2019

(54) INTEGRATED WHEEL ASSEMBLIES USING MOTOR AND SPEED REDUCER

(71) Applicant: DIVERGENT TECHNOLOGIES, INC., Los Angeles, CA (US)

(72) Inventor: John Russell BUCKNELL, El Segundo, CA (US)

(21) Appl. No.: 15/829,838

(22) Filed: Dec. 1, 2017

(51) Int. Cl. B60L 11/18; B60K 7/00; B60G 3/18; B60T 1/06; B60K 17/14; F16H 7/02; B60K 17/04

(52) U.S. Cl. CPC B60L 11/1851; B60K 7/0007; B60G 3/18; B60K 17/043; B60K 17/14; F16H 7/02; B60T 1/065

(57) ABSTRACT

Wheel assembles using integrated motors and speed reducers for electric vehicles are disclosed for providing improved structural efficiency. A wheel assembly may include a motor for providing power to a wheel, a leading or trailing type or similar suspension link, a caliper mounted to the suspension link and configured to engage a friction brake rotor on the wheel, and a synchronous belt mounted off-axis for implementing speed reducing. In certain embodiments, the respective components of the wheel assembly are nested to fit into a minimal volume. In other embodiments, the wheel assembly includes a motor that is not nested and that is configured to supply power to the wheel via a belt and pulley system.

### BACKGROUND

### Field

The present disclosure relates generally to transport structures, and more specifically to techniques for powering electric vehicles using an integrated wheel assembly having a motor and speed reducer.

### Background

Existing wheel assemblies in compact vehicles and other transport structures require a structurally efficient mechanism for providing motion via a motor, as well as providing appropriate braking and energy recovery techniques. These wheel assemblies, for example, should include a motor and speed reducer system that accounts for the often-limited space available in the relevant portion of the vehicle, that works efficiently with the existing suspension system, that enables recovery of kinetic energy through regenerative braking, and that facilitates dynamic torque vectoring, among other desirable features and objectives.

Any such system should further take into consideration the desired positioning of adjacent wheels relative to each other, wherein such positioning is a function of the architecture of the overall transport structure. For example, certain transport structures such as compact electric vehicles using leading or trailing link type or similar suspension systems require the wheels to be positioned closely while concurrently allowing for a degree of freedom between the wheels. Furthermore, for compact transport structures in which efficiency is a key concern, these integrated wheel assemblies should include a minimal overall mass and volume, which in turn increases overall efficiency of the vehicle within which such wheel assemblies are used.

A wheel assembly architecture that accomplishes these and other objectives is the subject of this disclosure.

### SUMMARY

Several aspects of integrated wheel assembly systems used in compact electric vehicles and other transport structures will be described more fully hereinafter with reference to various illustrative aspects of the present disclosure.

In one aspect of the present disclosure, a wheel assembly for a vehicle includes a wheel support structure, a motor having an output coupled to the wheel support structure, and a synchronous belt connecting the motor output off-axis to the wheel support structure to match wheel and motor speeds, wherein the synchronous belt is configured to slow wheel rotation in response to directional reversal of torque of the motor.

In another aspect of the present disclosure, an apparatus includes a wheel, an apparatus includes a wheel, a motor configured to mobilize the wheel, a suspension link coupled to the motor, and a braking mechanism including a brake caliper coupled to the suspension link and configured to engage a friction brake rotor mounted on the wheel for providing a brake force to the wheel.

In still another aspect of the present disclosure, a wheel assembly for a vehicle includes a wheel, a radial flux motor configured to mobilize the wheel, a leading or trailing type suspension link coupled to the motor, and a brake caliper coupled to the suspension link and configured to engage a friction brake rotor mounted on the wheel for providing a brake force to the wheel.

Different wheel assembly systems using integrated motors and speed reducers are disclosed that have not previously been developed or proposed. It will be understood that other aspects of wheel assemblies will become clear to those skilled in the art based on the following detailed description, wherein only several embodiments are described by way of illustration. As will be appreciated by those skilled in the art, these wheel assemblies can be realized with other embodiments without departing from the spirit and scope of the invention. Accordingly, the drawings and detailed description are to be regarded as illustrative in nature and not as restrictive.

### BRIEF DESCRIPTION OF THE DRAWINGS

Various features of wheel assemblies using integrated motors and speed reducers will now be presented in the detailed description by way of example, and not by way of limitation, in the accompanying drawings, wherein:

FIG. 1 is a perspective view of a solar extended range electric vehicle.

FIG. 2A is a plan view of a solar extended range electric vehicle in mobile mode.

FIG. 2B is a perspective view of the solar extended range electric vehicle in mobile mode.

FIG. 3A is a plan view of a trailing link type suspension.

FIG. 3B is an elevation view of a leading link type suspension.

FIG. 4 is a side view of the solar extended range electric vehicle using non-nested wheel motors.

### DETAILED DESCRIPTION

The detailed description set forth below with reference to the appended drawings is intended to provide a description of exemplary embodiments of wheel assembly systems in electric vehicles and other transport structures. The description is not intended to represent the only embodiments in which the invention may be practiced. The term “exemplary” used throughout this disclosure means “serving as an example, instance, or illustration,” and should not necessarily be construed as preferred or advantageous over other embodiments presented in this disclosure. The detailed description includes specific details for providing a thorough and complete disclosure that fully conveys the scope of the invention to those skilled in the art. However, the invention may be practiced without these specific details. In some instances, well-known structures and components may be shown in block diagram form, or omitted entirely, to avoid obscuring the various concepts presented throughout this disclosure.

In one aspect of the present disclosure, a wheel assembly using an integrated motor and speed reducer is disclosed. The wheel assembly and its integrated components represent a structurally efficient solution for a compact transport structure. In an exemplary embodiment, the wheel assembly accommodates a leading or trailing link type and/or other suspension system and uses an electric motor to deliver power to the wheel. In another embodiment, a regenerative braking technique is implemented using an synchronous belt coupled off-axis to the motor that transfers kinetic energy to the motor in a generator mode when a vehicle speed is reduced in response to a reverse directional torque applied to the motor. The transferred kinetic energy may thereupon be transmitted as electrical energy to an energy storage device. In an embodiment, the storage device may include the vehicle battery. The battery or other storage device may be integrated into a compact and efficient wheel system as described herein. In an embodiment, the reverse directional torque may be initiated by the act of braking the vehicle. In another embodiment, the process may be initiated by the driver releasing the accelerator.

In another embodiment, the wheel assembly includes an efficient braking system for executing braking wherein a caliper may be coupled to a suspension link and may be used with brake pads to engage a brake rotor mounted on the wheel. The brake rotor in another exemplary embodiment has a large diameter and accommodates a comparatively small, low-mass caliper to increase braking efficiency while maintaining an overall compact size. The leading/trailing end link suspensions or steerable uprights in one embodiment includes a swing arm type suspension link. The swing arm suspension link may in another embodiment include a ball joint at an end for steerable assemblies to accommodate a degree of freedom between adjacent and closely positioned wheels.

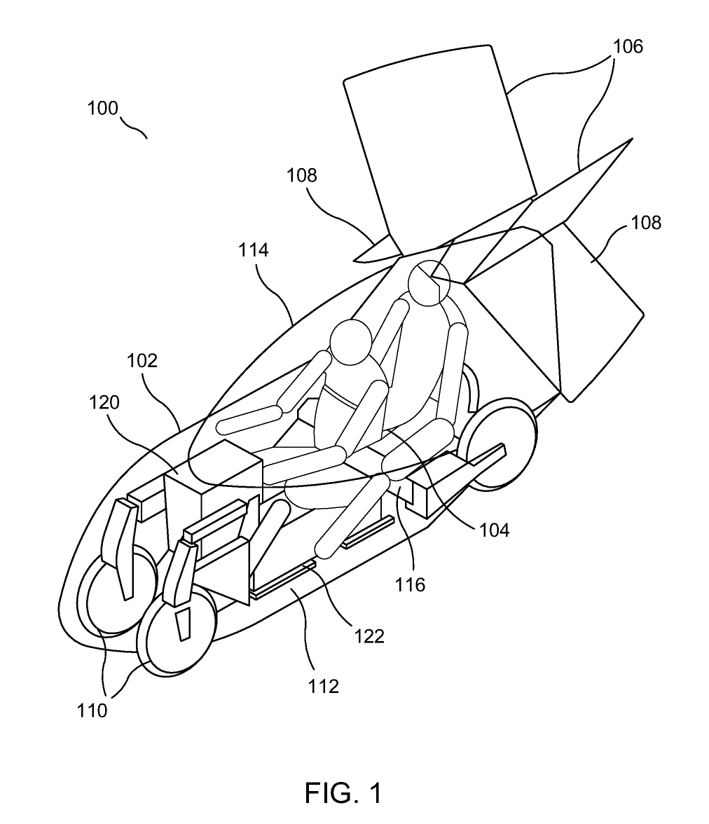

FIG. 1 is a perspective view of a solar extended range electric vehicle 100 in which the wheel assembly as described herein may be implemented. It will be appreciated that the electric vehicle 100 represents a non-exhaustive illustration of a vehicle suitable for use with the wheel assembly described herein, and that any number of equally-suitable vehicle architectures may be contemplated for use with the subject wheel assembly.

The vehicle 100 may include an aerodynamically contoured frame 102, a transparent or semi-transparent canopy 114, a body structure 112, a suspension system 116 mounted to the body structure 112, center console 120, battery cells 122, and dual inline seating 104 to accommodate two occupants in this embodiment.

In addition, deployable solar panel arrays 106, 108 may be attached to the vehicle. In an embodiment, the arrays 106, 108 may be constructed such that when deployed, they are located on either side of the tail. In this embodiment, the deployed arrays cover a total area of approximately three square meters, although the necessary surface area may in practice vary widely depending on numerous factors including characteristics of the vehicle. Arrays 106, 108 can be stowed during motion to the vehicle to improve aerodynamic characteristics. Solar panel arrays 106, 108 may continue to absorb solar energy and may provide sufficient energy for tasks like commuting and when folded or stowed to their original, low drag position as the vehicle moves In some embodiments, two-axis solar tracking can improve array effectiveness by a multiple in the range of approximately 1.3-1.8 or potentially greater.

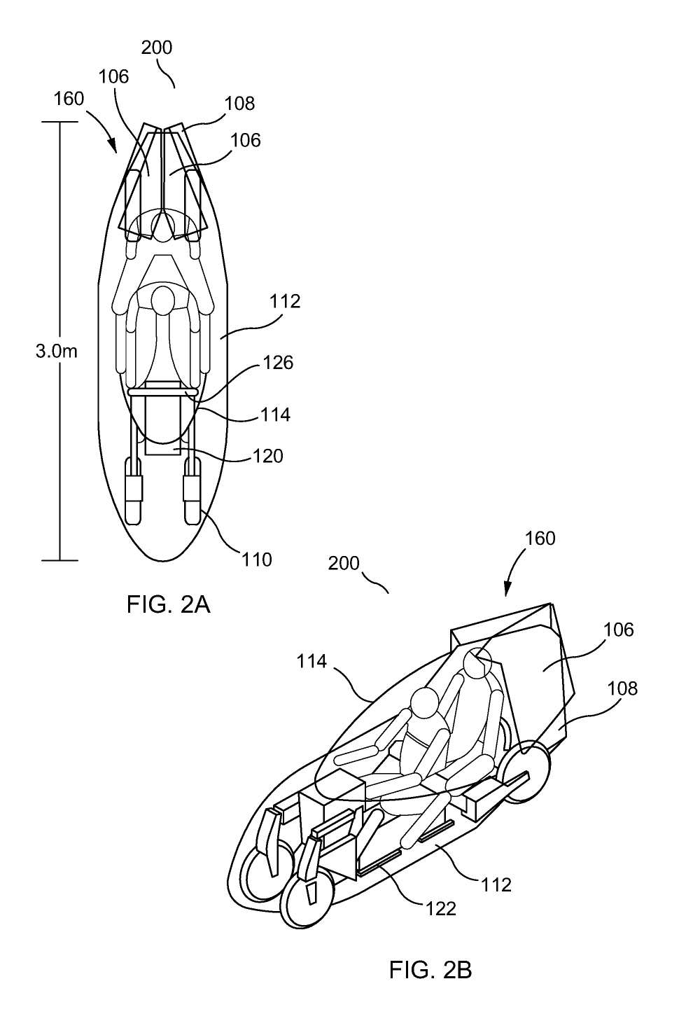

FIGS. 2A-B are respective plan and perspective views of a solar extended range electric vehicle 200 in mobile mode. As shown in FIGS. 2A-B, the solar panels 106 and 108 are stowable by being foldable substantially flush against tail section 160 of the vehicle 200. Thus, to deactivate the solar panels and prepare for a more aerodynamically efficient mobile mode, lower solar panels 108 may first be folded downward flush along a frame of tail section 160 (FIG. 2B). Thereupon, upper panels 108 may next be folded downward flush along exposed surfaces of upper panels 106. In this way, the amount of surface area and hence the drag decreases substantially, and the vehicle 200 is ready to be driven.

FIG. 2A further shows the handlebar 126 steering mechanism, and a portion of battery pack 122 which may be disposed under the passengers in this example. The front passenger shown in FIG. 2A is adjacent center console 120, which may include electronics for the various components and in other embodiments, some storage area, or a combination thereof. In certain embodiments, one of nose section or tail section 160 may include modest accommodations for storage (e.g., a few grocery bags). A suspension system 116 (FIG. 1) may be mounted to body structure 112 and coupled to wheel system 110.

In an exemplary embodiment, each of the four wheels of the electric vehicle is powered by a compact mechanical rotary machine. In an embodiment, this machine may constitute an electric motor. In other embodiments, less than four motors may be used to power vehicular movement. In other embodiments, a dual-motor system may be implemented to power different axles. The electric motor may be any known type. An embodiment using an electric radial flux machine is optimal.

A radial flux motor is a type of high performance electric motor having considerable size, weight, performance, and efficiency advantages when compared to traditional electric motors. More specifically, radial flux motors are current state of the art electric motors for power density (kW/kg) and energy efficiency. They are right circular cylinders with aspect ratios (D/L) of between 1:1 and 1:2. The motors have speed ranges that are ordinarily not well-matched to the speed range of drive wheels in passenger vehicles. Speed reducing transmissions in some embodiments may consequently be necessary, usually for an approximate 5:1 speed reduction.

Architecture for integrated wheel assemblies using motor and speed reducer for structurally efficient suspension systems. In conventional braking systems, the excess kinetic energy associated with the vehicle's forward movement is converted to heat due to friction in the brakes. In accordance with an aspect of the disclosure, the integrated motor and speed reducing mechanism employ regenerative braking to enable recapture and conversion of the kinetic energy into electricity. This electricity can thereupon be used to recharge the battery. The efficiency of this conversion can be made very high based on the overall low mass of the assembly.

Furthermore, in accordance with this aspect of the disclosure, the speed reducing mechanism for kinetic energy conversion may be integrated with a blended braking system that efficiently combines friction and electrical braking. Accordingly, the wheel assembly as described in this embodiment may result in a very structurally efficient integration of these functions due to the highly compact nature and low mass of this wheel design. These features have broad application, but may be particularly desirable in cases, for example, where the vehicle design is limited by significant volume and mass constraints, where the vehicle requires closely spaced adjacent wheels, and/or where the vehicle is configured to use a leading or trailing link or similar suspension mechanism that provides a tight horizontal bond of the axle while allowing wheel motion to facilitate isolation of cabin from road inputs.

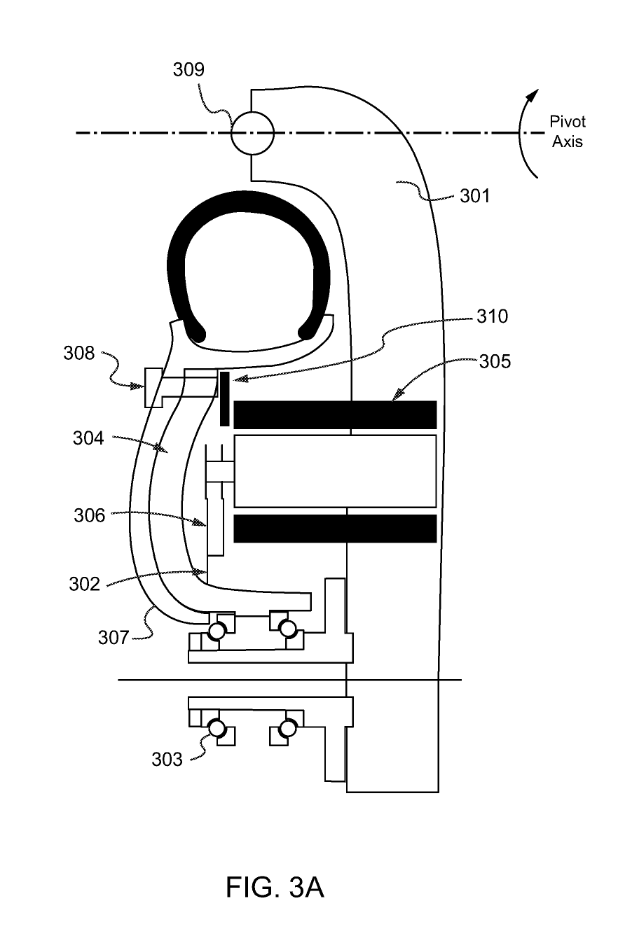

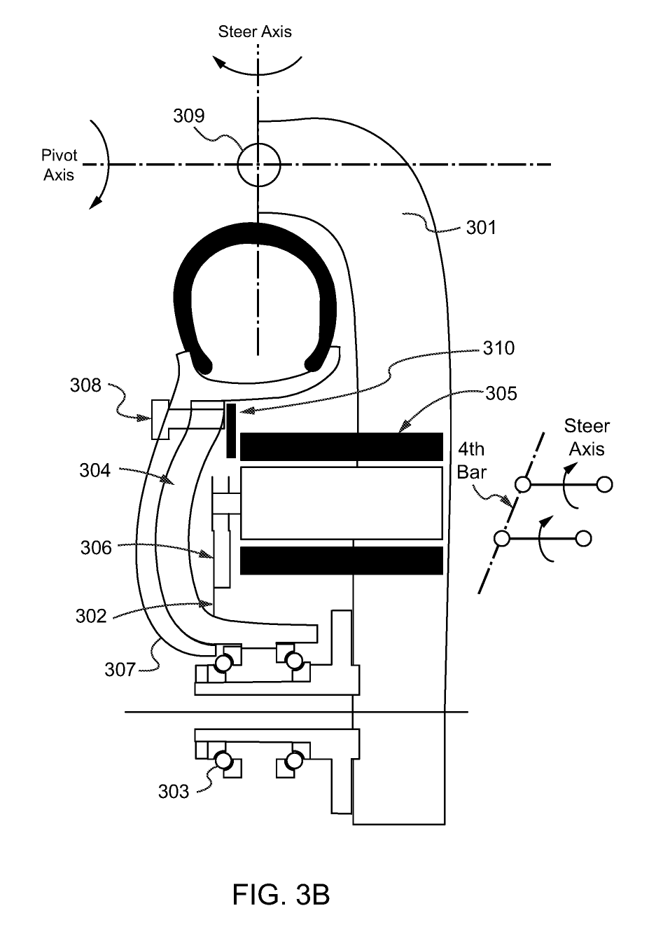

FIG. 3A is a plan view of a trailing link type suspension in an exemplary embodiment.

FIG. 3B is an elevation view of a leading link type suspension used in an embodiment with the trailing link structure of FIG. 3A. In this embodiment, the trailing and leading links are similar in structure, except that the leading link in FIG. 3B may employ a fourth bar 488 for steering, with relevant directional axes shown. In other embodiments, the trailing and leading links may differ substantially in structure. In an embodiment, the vehicle in FIGS. 3A-B uses a linkage 301 suspension system. As noted above, the linkage 301 may be used to hold the axle firmly, while providing a single degree of freedom that allows wheel motion, to allow the suspension to absorb bumps in the road. The assembly shows linkage 301, at one end of which is a pivot or steer axis 309 that allows linkage motion relative to the vehicle. For trailing link or swing arm suspensions, a single degree of freedom is needed. Conversely, for a steerable axle carrier (also known as upright), two degrees of freedom are important. Radial flux electric motor 305 is coupled to linkage or upright 301 via nesting. In the embodiment shown, one radial flux motor 305 may be present at or adjacent every wheel, although in other embodiments, one motor 305 may be used per axle. As noted above, other motors and motor configurations are also possible.

Wheel fastener 308 is also shown coupled to wheel support structure 304 adjacent wheel and tire assembly 307. Wheel support structure 304 may include the bearing 303, bearing assembly, spindle, hub axle and mounting flange. Wheel fasteners 308 may constitute threaded bolts or similar devices used to clamp the wheel via the mounting flange of the hub axle and prevent the wheel from sliding off. Between radial flux electric motor 305 and wheel fastener 308 is brake rotor 310. A brake caliper clamp may be mounted to linkage 301 to apply pressure to the brake rotor 310 via brake pads to stop the wheel from spinning and to thereby accomplish a brake force reaction.

An integrated wheel design with lowest mass will react to the loads of braking through the shortest structural path from the tire contact patch. Accordingly, in an embodiment, friction brake rotor 310 is mounted at the largest diameter, which consequently drives the lowest brake caliper clamp load for skid-torque which, in turn, drives a lowest mass brake caliper. The brake caliper is mounted to swing arm 301. In an embodiment, the wheel design provides efficient structure by integrating speed reduction and brake force reaction.

Speed reduction in an exemplary embodiment may be accomplished using a synchronous belt 306 through an off-axis pulley, which generally constitutes the lowest mass speed reducer embodiment. A separate drive pulley 302 may be mounted to the wheel axis and integrated with the wheel support structure 304. Nesting may allow assembly of the radial flux motor 305 to linkage 301, as noted above. Nesting may further allow assembly of the synchronous belt 306 with the wheel support structure 304, and may also allow assembly of the wheel and tire assembly 307 through wheel fasteners 308. This nested packaging advantageously may provide a very short axial length for the wheel 307, motor 305, and linkage 301 assembly, which in turn may enable a very narrow spacing between adjacent wheels—particularly if the suspension requires a steering degree of freedom. Steer axis 309 may provide a mechanism to enable this additional degree of freedom for a trailing link suspension, or two degrees of freedom for an upright arrangement.

Synchronous belts 306 are generally toothed and may in some embodiments require the installation of mating group sprockets. Because they can transfer torque via the teeth and do not require heat-producing friction to generate torque as in V-belts, synchronous belts 306 can in some embodiments be more efficient than V-belts or other conventional belts. The wheel and tire assembly 307 may be supported from both external and internal forces by wheel support structure 304. The motor 305 and the belts may be used to drive the wheel and tire assembly 307.

In an embodiment, the wheel support structure 304 may include a spoked wheel with a rim that affixes the friction brake rotor 310 at its outer diameter. The wheel itself is structurally very efficient with stiff structure only at the rim connected to the radial support structure. Additional lightweight structure connects the rim to a means of piloting at the wheel center for concentricity to the wheel bearing. By this means, additional structure for reacting the braking forces may be eliminated.

In an exemplary embodiment for speed reduction and kinetic energy recovery, the radial flux motor(s) 304 may be reversed such that the motors are absorbing torque instead of generating it, and synchronous belt 306 slows the wheel. Kinetic energy may be recovered from this directional reversal of torque to generate electric current. Radial flux motors 304 may thereupon function as a generator and may charge the battery using the electric current. This speed-reduction process can be automated in a number of ways. For example, the process may be initiated by applying the brakes or alternatively, by releasing the accelerator. In an embodiment, the type and manner of such automation and the use of the speed reducing mechanism in concert with, or as opposed to, the use of the brake caliper for slowing/stopping the vehicle may be governed by a separate blended brake controller, integrated circuit, or other processing system.

The above wheel assembly configuration allows torque vectoring stability control in narrow track leaning vehicles through steer torque and lean angle sensing. With a four-wheel configuration, torque-vectoring control is enabled in all modes—namely, yaw, understeer and oversteer—as well as enabling a high overturning moment via leaning for optimal vehicle dynamics.

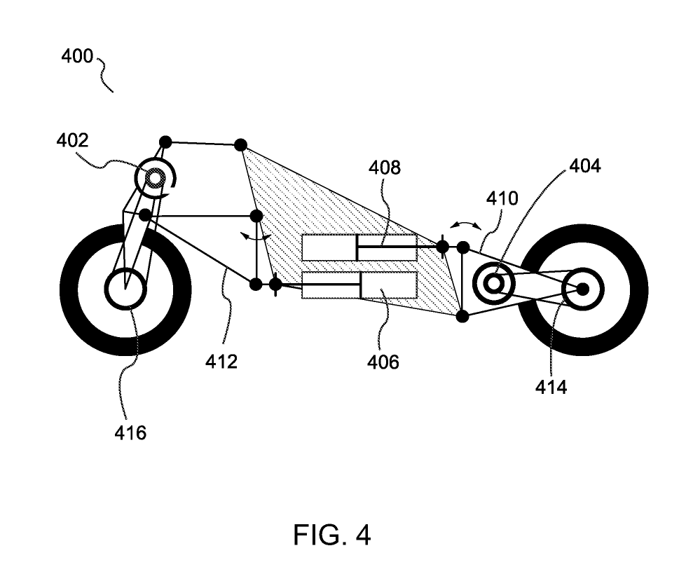

FIG. 4 is a side view of an embodiment of the solar extended range electric vehicle 400 using non-nested wheel motors 402 and 404. In this exemplary embodiment, wheel motors 402 for the front wheel/axle and 404 for the rear wheel/axle need not be nested with the wheels but rather may be displaced from the wheels. Thus, for example, wheel motor 402 uses a belt mounted on front wheel pulley 416 to provide power to the front wheel. Wheel motor 404, in turn, uses a belt mounted on rear wheel pulley 414 to provide power to the rear wheel. This configuration may be suitable for example, in embodiments in which less volume is available adjacent the wheels for providing a motor. Displacement of the motors 402 and 404 to a non-nested position accords flexibility in these embodiments.

FIG. 4 further shows rear suspension link 410, which may be, for example, a swing arm type suspension link, and front suspension link 412. Damper 406 is coupled to front suspension link 412. Damper 408 is coupled to rear suspension link 410.

The previous description is provided to enable any person skilled in the art to practice the various aspects described herein. Various modifications to the exemplary embodiments presented throughout this disclosure will be clear to those skilled in the art, and the concepts disclosed herein may be applied to other wheel assembly techniques. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

1. A wheel assembly for a vehicle, comprising:
a wheel support structure;
a motor having an output coupled to the wheel support structure; and
a synchronous belt connecting the motor output off-axis to the wheel support structure to match wheel and motor speeds,
wherein the synchronous belt is configured to slow wheel rotation in response to directional reversal of torque of the motor.

2. The assembly of claim 1, further coupled to a suspension link.

3. The assembly of claim 2, wherein the suspension link comprises a leading link type.

4. The assembly of claim 3, wherein the leading link type comprises a single degree-of-freedom (DOF) linkage.

5. The assembly of claim 3, wherein the linkage is one bar of a four bar linkage.

6. The assembly of claim 5, wherein the linkage has 2 degrees of freedom (DOF) relative to the vehicle by being connected to the leading link via a spherical joint.

7. The assembly of claim 1, wherein kinetic energy recovered from the directional reversal of torque of the motor produces electric current stored in the battery.

8. The assembly of claim 1, wherein the motor is configured to add or subtract rotational energy to or from the wheel using an energy storage device.

9. The assembly of claim 1, wherein the motor comprises an electric motor.

10. The assembly of claim 8, wherein the energy storage device is an electric battery.

11. The assembly of claim 9, wherein the electric motor comprises a radial flux motor.

12. The assembly of claim 1, further comprising a braking mechanism.

13. The assembly of claim 12, wherein the braking mechanism comprises a friction brake, the friction brake having a brake caliper mounted on the linkage and configured to engage a friction brake rotor.

14. The assembly of claim 1, wherein the motor output is coupled to the wheel support structure via a speed reducing transmission.

15. The assembly of claim 3, wherein one or more components use a nested packaging configured to enable assembly of:
the motor to the linkage;
the synchronous belt to the wheel support structure; and
wheel fasteners to the wheel.

16. The assembly of claim 1, wherein the wheel support structure comprises at least one bearing, a spindle, an axle hub and a mounting flange.

17. An apparatus, comprising:
a wheel;
a motor configured to mobilize the wheel;
a suspension link coupled to the motor; and
a braking mechanism comprising a brake caliper coupled to the suspension link and configured to engage a friction brake rotor mounted on the wheel for providing a brake force to the wheel.

18. The apparatus of claim 17, wherein the brake caliper comprises a hydraulic brake caliper.

19. The apparatus of claim 17, further comprising a synchronous belt connecting the motor off-axis to the wheel to match wheel and motor speeds,
wherein the synchronous belt is configured to slow wheel rotation in response to directional reversal of torque of the motor.

20. The apparatus of claim 17, wherein the motor is configured to add or subtract rotational energy to or from the wheel using an energy storage device.

21. The apparatus of claim 17, wherein the suspension link comprises a leading link suspension link.

22. The apparatus of claim 17, further comprising a speed reducing transmission coupled between an output of the motor and the wheel.

23. The apparatus of claim 17, wherein the motor is coupled via a belt to an axle of the wheel using a pulley.

24. A wheel assembly for a vehicle, comprising:
a wheel;
a radial flux motor configured to mobilize the wheel;
a leading type suspension link coupled to the motor; and
a brake caliper coupled to the suspension link and configured to engage a friction brake rotor mounted on the wheel for providing a brake force to the wheel.
